(19) United States
(12) Patent Application Publication
(10) Pub. No.: US 2006/0015569 A1
(43) Pub. Date: Jan. 19, 2006

(54) Method and system for initiating a task and receiving task data via a TWAIN interface

(75) Inventors: Samuel L. Rhodus, Danville, KY (US); Kenneth R. Wilkerson, Lexington, KY (US); Joel S. Young, Lexington, KY (US)

Correspondence Address: LEXMARK INTERNATIONAL, INC.;INTELLECTUAL PROPERTY LAW DEPARTMENT, 740 WEST NEW CIRCLE ROAD, BLDG. 082-1, LEXINGTON, KY, 40550-0999, US

(73) Assignee: Lexmark International, Inc.

(21) Appl. No.: 11/011,742

(22) Filed: Dec. 14, 2004

Related U.S. Application Data
(60) Provisional application No. 60/529,863, filed on Dec. 16, 2003.

(51) Int. Cl. G06F 3/00; G06F 15/16

(52) U.S. Cl. 709/217; 710/1

(57) ABSTRACT

A method, device, and computer readable medium for acquiring data from a device connected to a network and transferring the data to a host device. In one embodiment, the invention includes establishing a communication system; and establishing, on the host device, a data source configured to communicate with one or more devices. The data source may be a TWAIN data source. Embodiments may also include determining which of the one or more devices are operable with the data source; selecting one of the one or more devices that are operable with the data source; when available, transferring a device parameter from the one of the one or more devices that are operable with the data source to the host device; requesting an acquisition of data from the one of the one or more devices that are operable with the data source; delivering acquired data to the communication system; and sending the acquired data to an application program using the data source.

### BACKGROUND OF THE INVENTION

The present invention relates to communications between computer peripherals and, more particularly, to methods and systems for communicating with scanners or similar peripherals over a network using a TWAIN interface.

General-purpose, personal computers (such as computers that run Microsoft Windows or Apple Computer operating systems) may be connected to a variety of peripherals, such as printers, scanners, cameras, multi-function devices, etc. In general, communications with such peripherals require use of software known as a driver. The driver software knows how to communicate between an application program (such as a word processing program or image editing program) and the peripheral. Peripherals designed to capture images (e.g., scanners) are often designed to communicate according to a standard or specification known as TWAIN. A TWAIN driver or data source acts as an interface between any application that supports the TWAIN standard (e.g., Adobe Photoshop software) and a TWAIN-compliant peripheral (e.g., a scanner).

### SUMMARY OF THE INVENTION

Although adoption of the TWAIN standard has provided compatibility among scanners, computers, and software produced by a variety of different manufacturers, in its base form, the TWAIN standard does not specify communications with numerous networked devices. In general, a TWAIN driver has only supported a single peripheral connected directly to a computer (such as via a USB connection or parallel port). That is, implementations of the TWAIN specification have been configured in a one-to-one driver to device relationship. Accordingly, there is a need for improved methods and systems for communicating with networked peripherals using TWAIN interfaces.

One embodiment of the invention provides a method of acquiring data from a device connected to a network and transferring the data to a host device. The method may include establishing a communication system; and establishing, on the host device, a data source configured to communicate with one or more devices. The data source may be a TWAIN data source. The method may also include determining which of the one or more devices are operable with the data source; selecting one of the one or more devices that are operable with the data source; when available, transferring a device parameter from the one of the one or more devices that are operable with the data source to the host device; requesting an acquisition of data from the one of the one or more devices that are operable with the data source; delivering the acquired data to the communication system; and sending the acquired data to an application program using the data source.

In another embodiment, the invention provides a computer-readable medium containing instructions for acquiring data from a peripheral by: establishing a communication system; establishing, on a host device, a data source configured to communicate with one or more peripherals; determining which of the one or more peripherals are operable with the data source; selecting one of the one or more peripherals that are operable with the data source; when available, transferring a device parameter from the selected peripheral to the host device; requesting an acquisition of data from the selected peripheral; delivering the acquired data to the communication system; and sending the acquired data to an application program using the data source.

In yet another embodiment, the invention provides a host computer having a data source and a communication system. The data source is configured to, in conjunction with the communication system, discover a number of peripherals connected to the host computer through a network and enumerate the connected peripherals to a user of the host computer. When available, the data source transfers at least one device parameter from a selected peripheral to the host computer. The communication system is configured to receive data acquired by the selected peripheral and the data source is configured to deliver the acquired data to an application program on the host computer.

Other features and advantages of the invention will become apparent to those skilled in the art upon review of the following detailed description and drawings.

### BRIEF DESCRIPTION OF THE DRAWINGS

In the drawings:

FIG. 1 is an illustration of a system structured according to one embodiment of the invention.

FIG. 2 is a flow chart illustrating a process implemented in one embodiment of the invention.

FIG. 3 is an illustration of a graphical user interface that may be presented to a user in the system of FIG. 1.

FIG. 4 is a flowchart that provides additional details of steps 102-110 shown in FIG. 2.

FIG. 5 is a flowchart that provides additional details of steps 114-122 shown in FIG. 2.

It is to be understood that the invention is not limited in its application to the details of construction and the arrangement of components set forth in the following description or illustrated in the drawings. The invention is capable of other embodiments and of being practiced or of being carried out in various ways. Also, it is to be understood that the phraseology and terminology used herein is for the purpose of description and should not be regarded as limiting. The use herein of “including,” “comprising,” or “having” and variations thereof is meant to encompass the items listed thereafter and equivalents thereof as well as additional items. Unless limited otherwise, the terms “connected,” “coupled,” and “mounted,” and variations thereof herein are used broadly and encompass direct and indirect connections, couplings, and mountings. In addition, the terms “connected” and “coupled” and variations thereof are not restricted to physical or mechanical connections or couplings.

### DETAILED DESCRIPTION

Before embodiments of the invention are described in detail, a brief review of the TWAIN standard is provided. Nonetheless, it is assumed that the reader is familiar with the TWAIN specification (which is referenced below).

As noted, TWAIN is a standard for communicating with peripherals and, most commonly, scanners. The TWAIN standard also specifies an application programming interface for communicating with application software and “Data Source” software. Application software can be an imaging application, word processing application, or the like running on a personal computer. The application software acquires images or other data in accordance with the TWAIN specification (see, http://www.twain.org/docs/Spec1_{—}9_{—}197.pdf). The Data Source software refers to driver software installed on a personal or other computer (sometimes referred to as a “host computer”) to which a peripheral or source of information (such as a digital camera, scanner, or image database) is connected. The Data Source software controls the peripheral (e.g., an image acquisition device).

TWAIN communications involve three main components in a host computer: application software, “Source Manager” software, and Data Source software. In a TWAIN-compatible system, the communication among these three components must follow the TWAIN specification. The application software and Data Source software function as described above. The Source Manager software manages the interactions between the application software and the Data Source software. The Source Manager software may be a component of an operating system. The Source Manager may also be a component of a driver application.

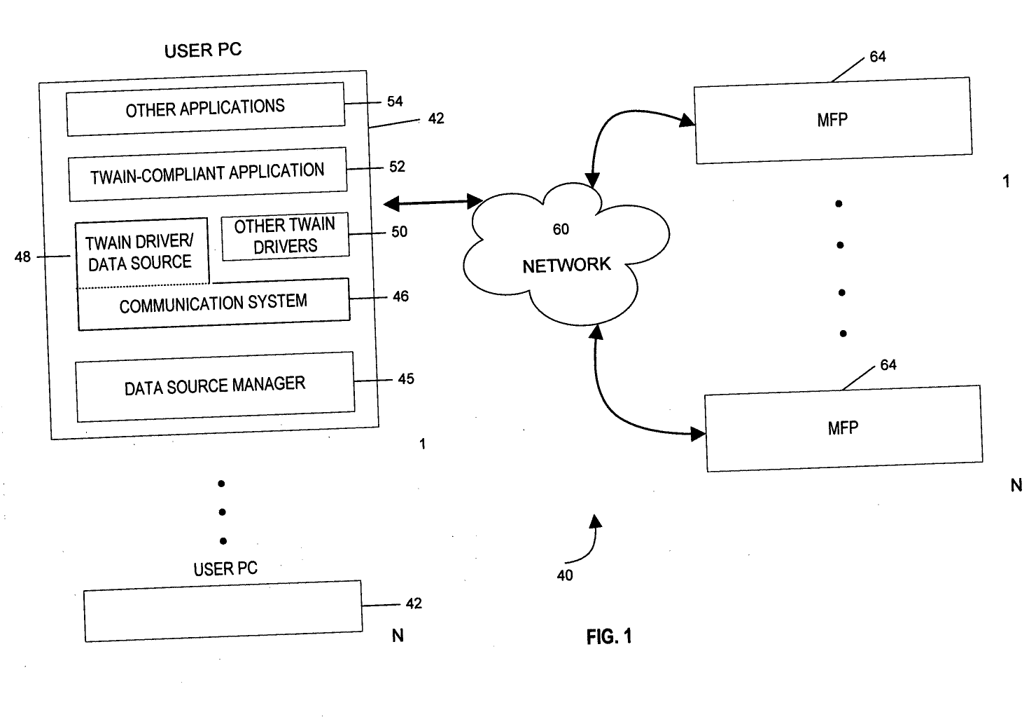

With reference to the Figures, various embodiments of the invention will now be shown and described. Like reference numerals are used to indicate the same element or step throughout the specification. FIG. 1 illustrates an exemplary system 40 constructed according to one embodiment of the invention. The system 40 includes a plurality of TWAIN-capable host devices or machines, such as personal computers 42. The computer 42 near the top, left-hand corner of FIG. 1 is illustrated in detail and, as shown, includes an operating system having a data source manager or DSM 45, communication system or CS software 46, and a TWAIN driver or data source 48. The communication system software 46 and data source 48 are shown as being parts of a single component, which performs the job of a driver. It should be noted that there could be multiple data sources loaded on the computer 42 and that the respective data sources could be designed so as to be separate from the communication system software 46.

The computer 42 may also include a plurality of other TWAIN drivers 50 (represented schematically) configured according to the prior art, one or more TWAIN-compliant applications 52 (such as Adobe Photoshop, Microsoft Word, and other similar software), and a variety of other application software 54.

Each of the computers 42 may include or be connected to a variety of common components and devices such as a monitor or display, keyboard, cursor-control device (e.g., a mouse, joystick, or touch screen), speakers, microphone, disk drive, solid-state memory, etc. (all not shown). The operating system software may be any commercially available operating system software such as Microsoft Windows XP or Apple OS software. Alternatively, the communication system software 46 may be proprietary software such as that manufactured by a peripheral manufacturer such as Lexmark. Although the details of the operation of such software are not generally known, manufacturers of peripherals generally implement some sort of communication system that interfaces with a TWAIN driver.

Each of the computers 42 is connected to a network 60. The network 60 may be any mechanism which allows a plurality of devices, such as peripherals and personal computers, to communicate with each other. For example, the network 60 may be a local area network (“LAN”) or wide area network (“WAN”). The network 60 may also be a wired or wireless network. A plurality of peripherals 64, such as multi-function peripherals (“MFP”) (devices that incorporate a scanner, printer, and copier in a single housing (also known as all-in-one (“AIO”) devices)) may be connected to the network 60. Of course, other peripherals such as cameras, printers, disk drives, storage devices, and the like could be connected to the network 60. Each peripheral may include a variety of well-known features such as a display (e.g., an LCD display) (not shown) to visually present information to a user and input mechanisms (such as key pads and buttons) to allow a user to make various selections of the options presented on the display.

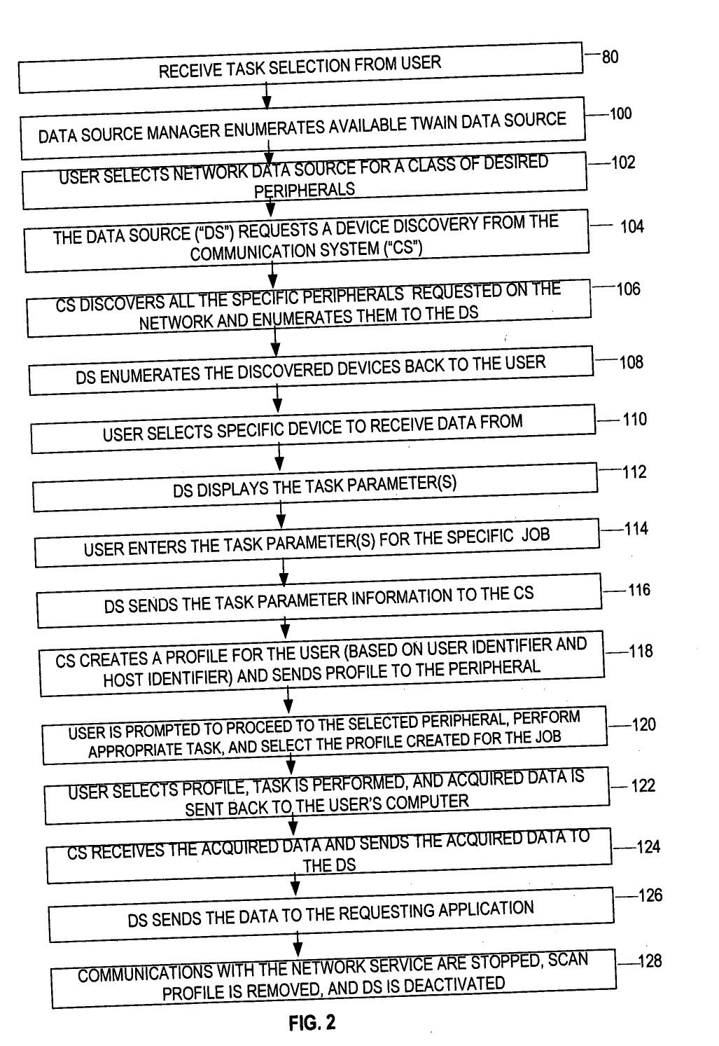

The system 40 is configured to allow a user of one of the plurality of computers 42 to find, and select for use, one of the plurality of peripherals 64 connected to the network 60. Unlike most implementations of the TWAIN specification, embodiments of the invention implement a one-to-many driver to device relationship. The overall process is illustrated in FIG. 2 and described below.

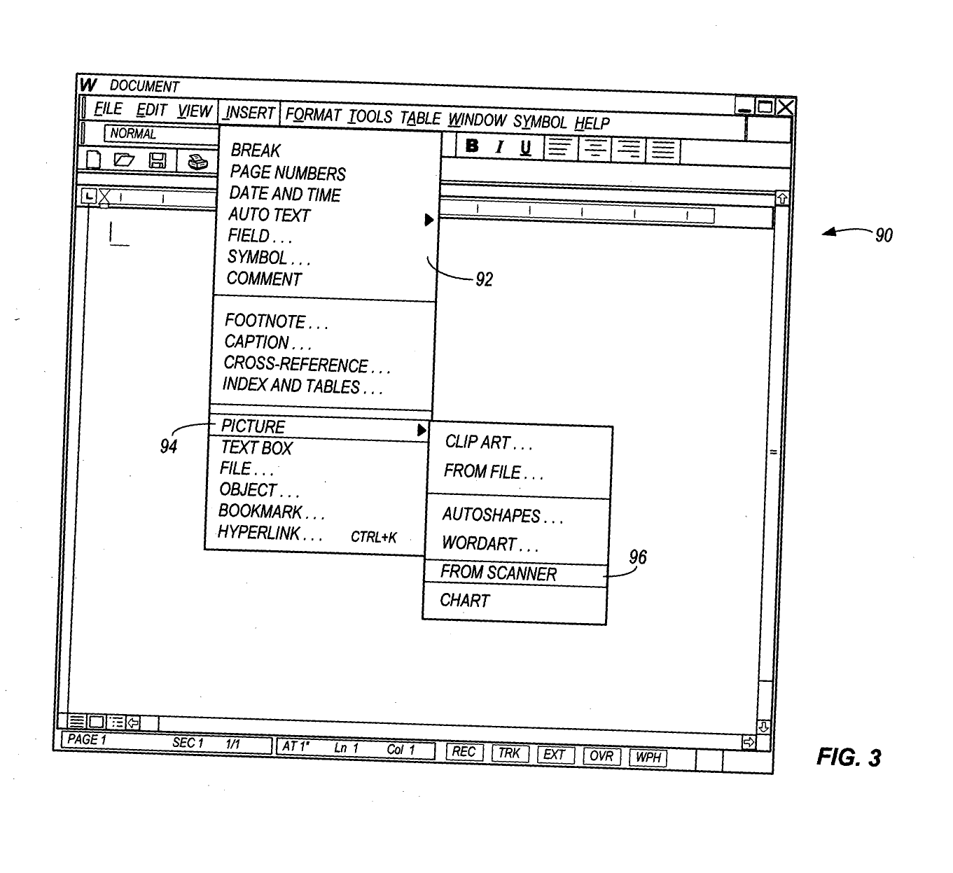

When a user wishes to use of one of the peripherals 64 to perform a task, such as scanning a document or photograph, the user inputs an appropriate selection using a graphical interface, as shown at step 80 in FIG. 2. An exemplary graphical user interface 90 (generated, for example, by the operating system and one of the application programs 54) is shown in FIG. 3. As shown, the user may choose to insert a picture from a scanner using an insert menu 92, a picture option 94, and a “From scanner” option 96.

Once the user makes the input selections indicating a desire to scan or acquire information from a peripheral, the data source manager 45 enumerates all available data sources on the host computer 42 to the user, as shown at step 100. In other words, the data source manager 45 searches the memory of the computer 42 to discover all of the data sources that have been installed on the computer and, in conjunction with the operating system, generates a user interface, such as a dialog box (not shown) listing the data sources that are installed and available for use, for example, one or more data sources 48 and other TWAIN drivers 50.

As shown at step 102, the user selects a data source 48 from the list of data sources generated in step 100 that matches the class of peripherals of interest to the user (e.g., the particular model type of a scanner). The data source selected by the user then requests a device discovery from the communications system 46 for the specific peripheral type that matches the selection made by the user, as shown in step 104.

The communication system 46 discovers all of the peripherals connected to or on the network 60 that match the type selection made by the user and sends a list of matching devices back to the selected TWAIN driver, as shown in step 106. This discovery process may be accomplished using commercially available open standard technologies, such as zero-configuration networking techniques. Alternatively, the discovery process may be accomplished by using proprietary technologies, such as the network printing alliance protocol (“NPAP”).

The data source 48 enumerates the discovered devices back to the user, as shown at step 108. As in step 100, an appropriate graphical user interface mechanism (such as a dialog box) may be provided on a monitor or display of the computer 42 to allow the user to make the desired selection. Once the graphical user interface mechanism is displayed, the user selects the specific peripheral that the user desires to receive data from, as shown at step 110.

Once the selection is made by the user, the data source associated with the type of device selected, in conjunction with the application program 52, generates a graphical user interface mechanism, such as a dialog box with radio buttons or check boxes, so that the user can view task parameters, such as peripheral or scan parameters, that must be provided to carry out the desired task, as shown at step 112. The task parameters may include parameters such as paper size, resolution, color, depth, etc. The user then enters the task parameters (by, e.g., selecting the appropriate radio buttons or check boxes) for the specific peripheral job, as shown at step 114. The selected data source then sends the task parameter information to the communication system 46, as shown at step 116.

The communication system 46 creates a job or task profile for the user (based, e.g., on a user identifier and host identifier) and sends this profile to the selected peripheral device 64 connected to the network 60, as shown at step 118. The user is then prompted via a graphical user interface element or other element (such as a sound, etc.) (not shown) to proceed to the selected peripheral, perform the appropriate task (such as placing an item to be scanned in the scanner of the selected peripheral 64), and select the job profile that was created for the job, as shown at step 120. The display of the peripheral 64 may also display additional information, such as instructions or the profile.

Once the user selects the appropriate job profile, the task is performed by the peripheral (such as a scan), and any acquired data (such as scan data) is sent back to the computer 42 (being used by the user), as shown at step 122. The communication system receives the acquired data and sends that data to the selected TWAIN driver (e.g., data source 48), as shown at step 124. The TWAIN driver then sends the data to the requesting application 54 (step 126). After the last packet of data is received, communications with the peripheral may be stopped, the job profile may be removed from the peripheral, and the data source deactivated (step 128).

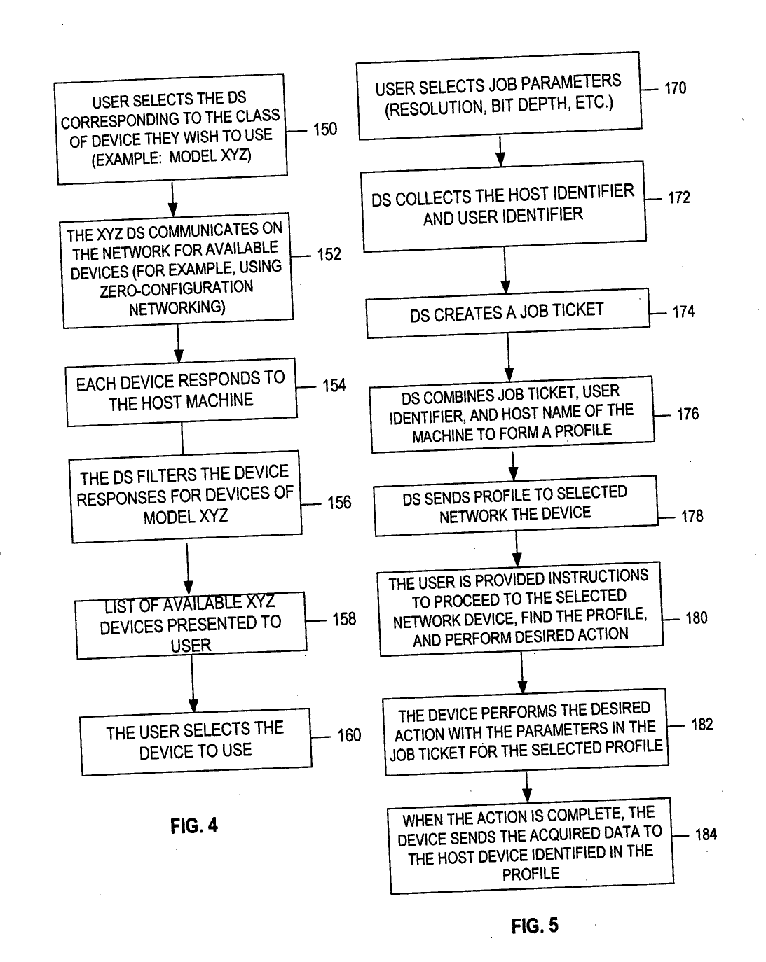

FIG. 4 illustrates steps 102-110 (discussed above) in greater detail. As shown at step 150 (in FIG. 4), after the available drivers have been enumerated, the user selects the data source that corresponds to the class of peripherals that could be used. The selected data source sends (e.g., via a broadcast, uni-cast, multicast, or other method) a message on the network 60 to determine which of the peripherals are available for use, as shown at step 152. Each available device responds to the host machine 42 (step 154), and the selected data source filters the response to determine which of the responding devices match the user-selected class of peripherals (step 156). The selected data source then generates a list of available peripherals of the selected class of peripherals, and the list is presented to the user (step 158). The user then selects the peripheral he or she desires to use (step 160). Alternatively, an appropriate data source could be automatically matched to the selected peripheral.

FIG. 5 is a flowchart that provides additional details of steps 114-122 shown in FIG. 2.

As shown in step 170, after available parameters, such as scan, data acquisition, or job parameters, have been presented to a user, the user inputs the desired parameters for the task at hand. The data source may then collect the host name or identifier of the computer 42 and a user name or identifier, such as the currently logged in user's name (step 172). The data source creates a job ticket containing the job parameters (step 174) and combines the job ticket, user identifier, and host identifier to form a job or task profile (step 176). The data source sends the job profile to the selected peripheral (178) and may also cause instructions to be generated and eventually displayed to a user on the computer 42 to proceed to the selected peripheral and perform the desired action (e.g., start a scan) (step 180). The selected peripheral performs the job with the parameters in the job ticket (step 182) and then sends the acquired data to the computer 42 that matches the host identified in the job profile (step 184).

As should be apparent to one of ordinary skill in the art, the systems shown in the figures are models of what actual systems might be like. Many of the components and logical structures described are capable of being implemented in software executed by a microprocessor or a similar device or of being implemented in hardware using a variety of components including, for example, application specific integrated circuits (“ASICs”). Furthermore, throughout the specification and claims, reference is made to various user interfaces. Although these interfaces are sometimes described as graphical in nature, it should be understood that other kinds of interfaces, such as audio or touch-sensory interfaces could be provided and that such interfaces could be implemented by those of ordinary skill in the art. Thus, unless specifically indicated otherwise, the claims should not be limited to graphical interfaces or to any specific hardware or software implementation or combination of software or hardware. In addition, capitalized terms are used. Use of such terms is made to be consistent with common industry practice. Nothing, however, should be construed as limiting the breadth of such terms merely because they have been capitalized.

Various features and advantages of the invention are set forth in the following claims.

1. A method of acquiring data from a device connected to a network and transferring the data to a host device, the method comprising:
establishing a communication system;
establishing, on the host device, a data source configured to communicate with one or more devices;
determining which of the one or more devices are operable with the data source;
selecting one of the one or more devices that are operable with the data source;
when available, transferring a device parameter from the one of the one or more devices that are operable with the data source to the host device;
requesting an acquisition of data from the one of the one or more devices that are operable with the data source;
delivering the acquired data to the communication system; and
sending the acquired data to an application program using the data source.

2. The method as claimed in claim 1, further comprising requesting a device discovery from the communication system.

3. The method as claimed in claim 2, further comprising delivering a device response enumerating discovered devices to the data source.

4. The method as claimed in claim 3, further comprising filtering the device response.

5. The method as claimed in claim 3, further comprising presenting a user interface to a user with an indication of the discovered devices.

6. The method as claimed in claim 4, further comprising providing an interface that permits a user to select one of the discovered devices.

7. The method as claimed in claim 1, further comprising collecting an identifier of the host device.

8. The method as claimed in claim 1, further comprising collecting an identifier of a user.

9. The method as claimed in claim 1, further comprising generating a job ticket from the device parameter from the one or more devices.

10. The method as claimed in claim 9, further comprising combining the job ticket, a host identifier, and a user identifier into a profile.

11. The method as claimed in claim 1, wherein establishing, on the host device, a data source configured to communicate with one or more devices includes establishing a TWAIN data source configured to operate in accordance to a one-to-many device relationship.

12. A host computer comprising:
a data source; and
a communication system, wherein
the data source configured to, in conjunction with the communication system, discover a number of peripherals connected to the host computer through a network and enumerate the connected peripherals to a user of the host computer, the data source also configured to, when available, transfer a device parameter from a selected peripheral to the host computer, and
wherein the communication system is configured to receive data acquired by the selected peripheral and the data source is configured to deliver the acquired data to an application program on the host computer.

13. The host computer as claimed in claim 12, wherein the data source is configured to request a device discovery from the communication system.

14. The host computer as claimed in claim 13, wherein the communication system is configured to deliver a device response enumerating discovered devices to the data source.

15. The host computer as claimed in claim 14, wherein the data source is configured to filter the device response.

16. The host computer as claimed in claim 13, wherein the data source is configured to cause a user interface to present a user an indication of the discovered devices.

17. The host computer as claimed in claim 16, wherein the user interface is configured to permit a user to select one of the discovered devices.

18. The host computer as claimed in claim 12, wherein the host computer has a host identifier and the data source is configured to collect the host identifier and a user identifier.

19. The host computer as claimed in claim 12, wherein the data source is configured to generate a job ticket from the device parameter from the one or more devices .

20. The host computer as claimed in claim 12, wherein the data source is configured to generate a profile.

21. The host computer as claimed in claim 20, wherein the data source generates the profile by combining a job ticket, a host identifier, and a user identifier.

22. The host computer as claimed in claim 12, wherein the data source is a TWAIN data source configured to operate in accordance to a one-to-many device relationship.

23. A computer-readable medium containing instructions for acquiring data from a peripheral by:
establishing a communication system;
establishing, on a host device, a data source configured to communicate with one or more peripherals;
determining which of the one or more peripherals are operable with the data source;
selecting one of the one or more peripherals that are operable with the data source;
when available, transferring a device parameter from the selected peripheral to the host device;
requesting an acquisition of data from the selected peripheral;
delivering the acquired data to the communication system; and
sending the acquired data to an application program using the data source.

24. The computer-readable medium as claimed in claim 23, further comprising instructions for requesting a device discovery from the communication system.

25. The computer-readable medium as claimed in claim 24, further comprising instructions for delivering a device response enumerating discovered devices to the data source.

26. The computer-readable medium as claimed claim 25, further comprising instructions for filtering the device response.

27. The computer-readable medium as claimed in claim 25, further comprising instructions for presenting a user interface to a user with an indication of the discovered devices.

28. The computer-readable medium as claimed in claim 25, further comprising instructions for providing an interface that permits a user to select one of the discovered devices.

29. The computer-readable medium as claimed in claim 23, further comprising instructions for collecting an identifier of the host device and an identifier of a user.

30. The computer-readable medium as claimed in claim 23, further comprising instructions for generating a job ticket from the device parameter.

31. The computer-readable medium as claimed in claim 30, further comprising instructions for combining the job ticket, a host identifier, and a user identifier into a profile.

32. The computer-readable medium as claimed in claim 23, further comprising instructions for establishing a TWAIN data source configured to operate in accordance to a one-to-many device relationship.
